(19) United States
(12) Patent Application Publication
(10) Pub. No.: US 2004/0039871 A1
(43) Pub. Date: Feb. 26, 2004

(54) Replacement memory device

(76) Inventors: Colin Stobbs, Eagle, ID (US); Kenneth K. Smith, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/228,994

(22) Filed: Aug. 26, 2002

(51) Int. Cl. G06F 12/00

(52) U.S. Cl. 711/103; 711/105

(57) ABSTRACT

A magnetic memory device capable of replacing a Flash memory within a computer, is provided. The magnetic memory device contains a magnetic storage device, a temporary memory having data access speed similar to Flash memory and a controller for controlling access to the magnetic storage device and the temporary memory.

### FIELD OF THE INVENTION

The present invention generally relates to storage of data and, more particularly, is related to a replacement memory device.

### BACKGROUND OF THE INVENTION

With advancements in technology, faster computers and devices are desirable. While many factors attribute to the speed of computers and devices, one factor of particular significance is memory access. Typically, memory provides a fast and temporary form of storage for data and/or instructions (typically in the form of a computer program) within a computer. It should be noted herein that the term computer comprises processor and memory enabled devices.

Many different types of memory are utilized within a computer. Examples of types of memory include, but are not limited to, read only memory (ROM), random access memory (RAM), and dynamic random access memory (DRAM). Computers typically comprise at least a small portion of ROM that stores instructions for starting a computer. As is implied by its name, ROM is a read only memory, thereby limiting its use within the computer.

RAM is typically used when a computer program, software, and/or data in general is loaded or opened within a computer. Specifically, RAM provides a temporary storage area for data that is retained until a central processing unit (CPU) can readily access the data. When required by the computer, the CPU requests data needed from the RAM, processes the data, and writes new data back to the RAM in a continuous cycle. When a computer program is closed, the computer program and any accompanying data are typically purged from the RAM to make room for new data. If new data is not saved to a permanent storage device before being purged, the data is lost.

DRAM, one of the more common types of RAM, stores each bit of data in a memory cell having a capacitor and a transistor. As is known by those of ordinary skill in the art, capacitors tend to lose their charge rather quickly. Therefore, DRAMs waste power since they require a constant current to maintain storage of bits of data. Specifically, in a DRAM configuration, a capacitor operates as a small bucket storing electrons. To store a “1” in a memory cell, the bucket is filled with electrons. Alternatively, to store a “0,” the bucket is emptied. In addition, DRAM requires refreshing thousands of times per second to retain a “1” in the memory cell.

Unfortunately, the above-mentioned types of memory are electronic forms of storage. As a result of the above memories being electronic forms of storage, a loss of power to the memories results in a loss of data stored therein. In addition, the above memories demand excessive use of power.

Another category of RAM is Flash RAM. Flash RAM is a type of nonvolatile memory that can be erased and reprogrammed in units of memory referred to as blocks. Since Flash RAM is nonvolatile memory, Flash RAM is based on a solid-state design, where there are no moving internal parts. In addition, to maintain storage of information, the Flash RAM does not require periodic refreshing. Therefore, Flash RAM is a solution to the requirement of excess power.

Flash RAM is often used to store control code, such as basic input/output system (BIOS), in a computer. When BIOS requires rewriting, the Flash RAM can be written to in block sizes, as opposed to byte sizes, making Flash RAM easy to update. Unfortunately, Flash RAM memory cells are damaged each time the memory cells write to a bit. Therefore, after approximately ten thousand (10,000) program/erase cycles, the Flash memory quits. Thus, while Flash memory prevails in consumer electronics, its lack of long-term reliability makes it a poor choice for memory in devices such as desktop computers.

Magnetic random access memory (MRAM) resolves the issues of reliability and lost data attributed to power loss. Unlike conventional RAM, which uses electrical cells to store data, MRAM uses magnetic memory cells. Since magnetic memory cells maintain their state even when power is removed, MRAM has a distinct advantage over DRAM and/or static RAM (SRAM) cells. In addition, portable devices using MRAMs have reduced battery power drain since MRAMs do not require continuous refreshing. Therefore, it would be beneficial to apply the benefits of MRAM to a system using Flash RAM, without requiring major changes to the system.

### SUMMARY OF THE INVENTION

In light of the foregoing, the preferred embodiment of the present invention generally relates to a magnetic memory device for replacing Flash memory within a computer.

Generally, with reference to the structure of the magnetic memory device, the device utilizes a magnetic storage device, a temporary memory having data access speed similar to Flash memory and a controller for controlling access to the magnetic storage device and the temporary memory.

The present invention can also be viewed as providing a method for providing a computer with magnetic storage capability. In this regard, the method can be broadly summarized by the following steps: replacing a Flash memory located within said computer with a magnetic memory device comprising a magnetic storage device, a temporary memory and a controller; copying data stored within the magnetic storage device to the temporary memory during initiation of the computer; storing data received by the magnetic memory device within the temporary memory; and transmitting a copy of the data received by the magnetic memory device from the temporary memory to the magnetic storage device.

### BRIEF DESCRIPTION OF THE DRAWINGS

The invention can be better understood with reference to the following drawings. The components of the drawings are not necessarily to scale, emphasis instead being placed upon clearly illustrating the principles of the present invention. Moreover, in the drawings, like referenced numerals designate corresponding parts throughout the several views.

FIG. 1 is a block diagram of a prior art computer in which the present replacement memory device may be provided.

FIG. 2 is a block diagram of a computer having the present replacement memory device therein.

FIG. 3 is a block diagram further illustrating the replacement memory device of FIG. 2.

FIG. 4 is a block diagram that further illustrates the MRAM device of FIG. 3.

FIG. 5 is a block diagram further illustrating a single memory cell of the MRAM device of FIG. 4.

FIG. 6 is a flowchart illustrating use of the present replacement memory device of FIG. 3.

### DETAILED DESCRIPTION

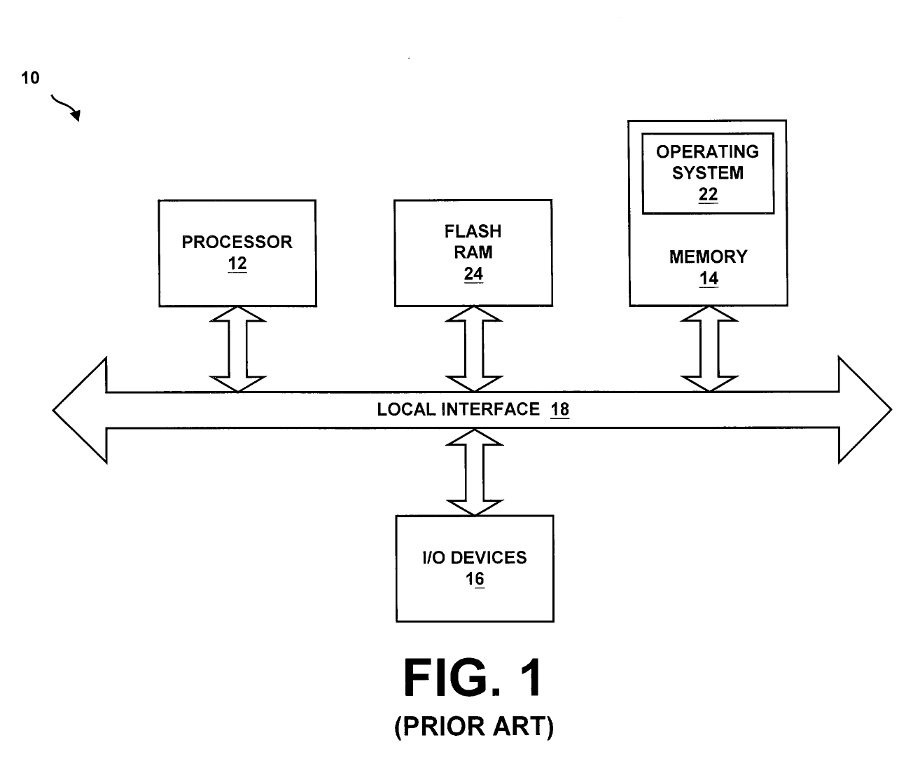

Referring now to the drawings, wherein like reference numerals designate corresponding parts throughout the drawings, FIG. 1 is a block diagram of a prior art computer 10 in which a replacement memory device may be provided. As is further described in detail below, the replacement memory device comprises a magnetic memory that can be used to replace a Flash RAM. In accordance with the first exemplary embodiment of the invention, the magnetic memory is a magnetic random access memory (MRAM), although it is not necessary that the magnetic memory be an MRAM.

Generally, in terms of hardware architecture, the computer 10 includes a processor 12, memory 14, and one or more input and/or output (I/O) devices 16 (or peripherals) that are communicatively coupled via a local interface 18. The local interface 18 can be, for example, one or more buses or other wired or wireless connections, as is known in the art. The local interface 18 may have additional elements, which are omitted for simplicity, such as controllers, buffers (caches), drivers, repeaters, and receivers, to enable communications. Further, the local interface 18 may include address, control, and/or data connections to enable appropriate communications among the aforementioned components.

The processor 12 is a hardware device for executing software, particularly that is stored in the memory 14. The processor 12 can be any custom made or commercially available processor, a central processing unit (CPU), an auxiliary processor among several processors associated with the computer 10, a semiconductor based microprocessor (in the form of a microchip or chip set), a macroprocessor, or generally any device for executing software instructions. Examples of suitable commercially available microprocessors are as follows: a PA-RISC series microprocessor from Hewlett-Packard Company, an 80x86 or Pentium series microprocessor from Intel Corporation, a PowerPC microprocessor from IBM, a Sparc microprocessor from Sun Microsystems, Inc, or a 68xxx series microprocessor from Motorola Corporation.

The memory 14 can include any one or combination of volatile memory elements (e.g., random access memory (RAM), such as dynamic RAM (DRAM), static RAM (SRAM), Flash RAM, magnetic RAM (MRAM), etc.)) and nonvolatile memory elements (e.g., read-only memory (ROM), hard drive, tape, compact disc read-only-memory (CDROM), etc.). Moreover, the memory 14 may incorporate electronic, magnetic, optical, and/or other types of storage media. Note that the memory 14 can have a distributed architecture, where various components are situated remote from one another, but can be accessed by the processor 12. The computer 10 may also include a separate storage device.

The software located within the memory 14 may include one or more separate programs, each of which comprises an ordered listing of executable instructions for implementing logical functions. The software includes a suitable operating system (O/S) 22. A nonexhaustive list of examples of suitable commercially available operating systems 22 is as follows: (a) a Windows operating system available from Microsoft Corporation; (b) a Netware operating system available from Novell, Inc.; (c) a Macintosh operating system available from Apple Computer, Inc.; (e) a UNIX operating system, which is available for purchase from many vendors, such as the Hewlett-Packard Company, Sun Microsystems, Inc., and AT&T Corporation; (d) a LINUX operating system, which is freeware that is readily available on the Internet; (e) a run time Vxworks operating system from WindRiver Systems, Inc.; or (f) an appliance-based operating system, such as that implemented in handheld computers or personal data assistants (PDAs) (e.g., PalmOS available from Palm Computing, Inc., and Windows CE available from Microsoft Corporation). The operating system 22 controls the execution of other computer programs within the computer 10, and provides scheduling, input-output control, file and data management, memory management, and communication control and related services.

The I/O devices 16 may include input devices, for example but not limited to, a keyboard, mouse, scanner, microphone, etc. Furthermore, the I/O devices 16 may also include output devices, for example but not limited to, a printer, display, etc. Finally, the I/O devices 16 may further include devices that communicate both inputs and outputs, for instance but not limited to, a modulator/demodulator (modem for accessing another device, system, or network), a radio frequency (RF) or other transceiver, a telephonic interface, a bridge, a router, etc.

If the computer 10 is a personal computer (PC), workstation, or the like, the software in the memory 14 may further include a basic input output system (BIOS) (omitted for simplicity). The BIOS is a set of essential software routines that initialize and test hardware at startup, start the O/S 22, and support the transfer of data among the hardware devices. The BIOS is stored in ROM so that the BIOS can be executed when the computer 10 is activated.

When the computer 10 is in operation, the processor 12 is configured to execute software stored within the memory 14, to communicate data to and from the memory 14, and to generally control operations of the computer 10 pursuant to the software stored within the memory 14.

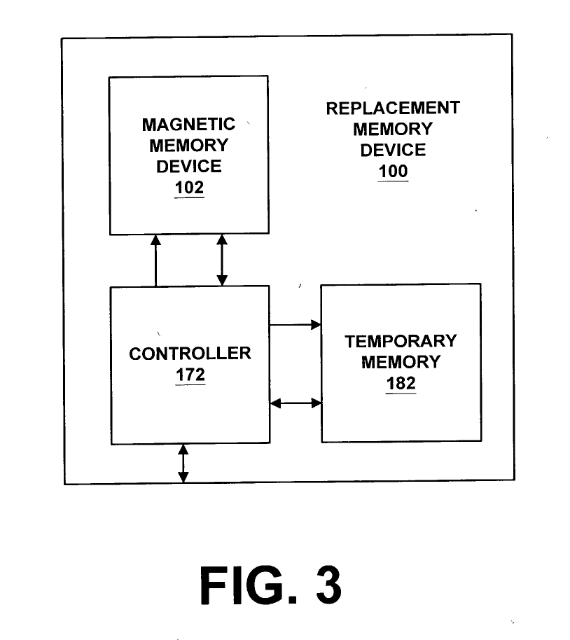

In accordance with the prior art computer 10, at least one Flash RAM 24 is located within the computer 10. It should be noted that, instead of an additional memory being located within the computer 10, namely, the Flash RAM 24, the memory 14 may be a Flash RAM. As is described below with reference to FIGS. 3-5, the replacement memory device is used to replace the Flash memory 24 and readily provide high density, high speed and a device that does not loose data when power to the computer 10 is lost.

In accordance with the first exemplary embodiment of the invention, the Flash RAM 24 (FIG. 1) to be replaced is a NOR Flash RAM, although a NAND Flash RAM may also be replaced. As known by those of ordinary skill in the art, NOR Flash RAM is randomly accessible, meaning that stored data can be read, and re-read, in any sequence or order. Therefore, NOR Flash RAM is well suited for code-storage applications, reprogrammable microcontrollers, and/or PC BIOS ROMs. In addition, since NOR Flash RAM has a parallel architecture, it is generally preferred over other architectures because of its reliability and fast read speeds.

Unlike NOR Flash RAM, NAND Flash RAM is sequentially accessible due to its serial architecture. Therefore, data contained in NAND Flash RAM is read in sequence, i.e. one byte following the next, in order. As such, NAND Flash RAM is ideal for data and/or file storage applications, examples of which include, but are not limited to, program files for a personal digital assistant (PDA), photograph data from a digital camera and MP3 files for a digital music player.

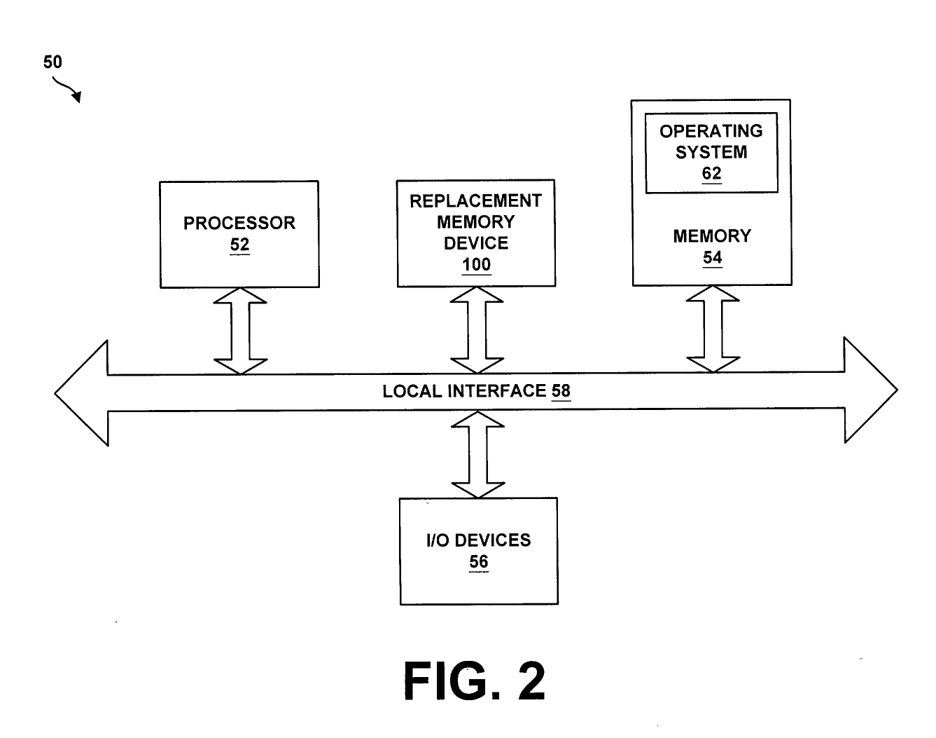

FIG. 2 is a block diagram of a computer 50 having the present replacement memory device 100 therein. As mentioned above, the replacement memory device 100 replaces either the memory 14 of FIG. 1, wherein the memory 14 (FIG. 1) is a Flash RAM, or the replacement memory device 100 replaces a separate Flash RAM 24 (FIG. 1). The following description assumes that the replacement memory device 100 is used to replace the separate Flash RAM 24 (FIG. 1). It should be noted that while the first exemplary embodiment of the invention provides the replacement memory device 110 within a computer, the replacement memory device 100 may be used in other systems having a processor.

As in the prior art computer 10 of FIG. 1, the present computer 50 includes a processor 52, a memory 54 and one or more input and/or output (I/O) devices 56 (or peripherals) that are communicatively coupled via a local interface 58. The memory 54 has an operating system 62 stored therein. In addition, the present computer 50 may also include a separate storage device.

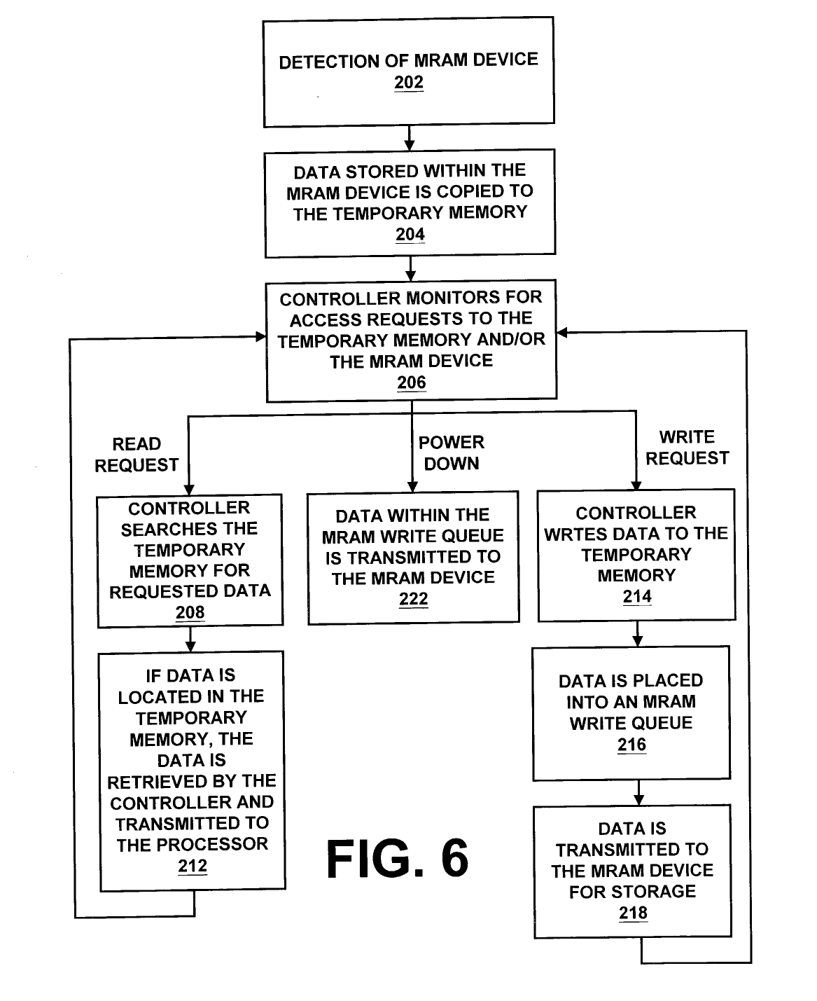

FIG. 3 is a block diagram further illustrating the replacement memory device 100 of FIG. 2. As shown by FIG. 3, the replacement memory device 100 contains a magnetic memory, e.g., MRAM, device 102, a controller 172 and a temporary memory 182. It should be noted that, while the following refers to a MRAM, other magnetic memories may be supplemented. The controller 172 may be any processing device, such as a microprocessor or a finite state machine (FSM), that is capable of transmitting data to, and reading data from, the MRAM device 102 and the temporary memory 182. Functionality of the controller 172 is described in detail with reference to the description of FIG. 6, which is provided below.

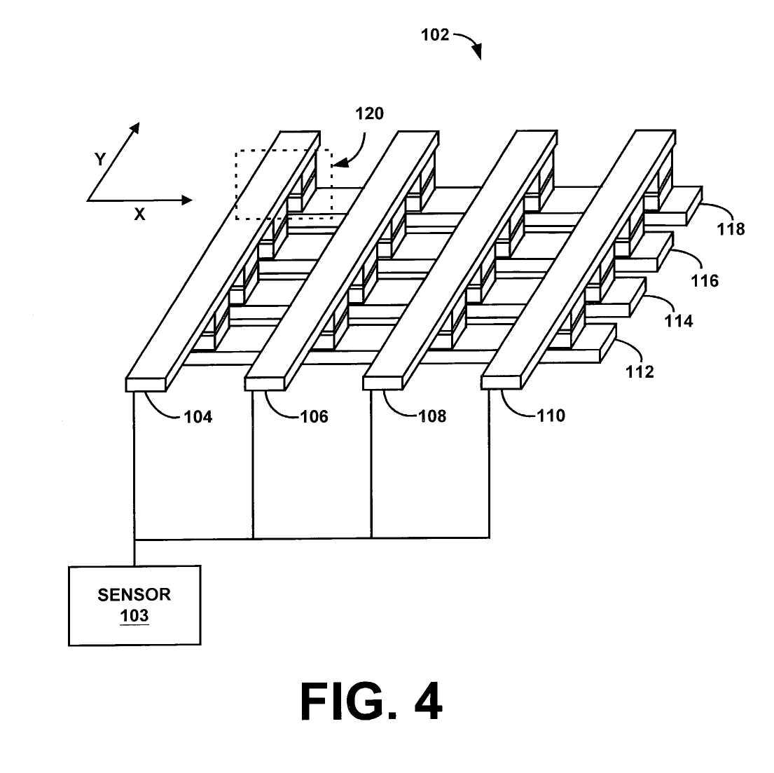

FIG. 4 is a block diagram further illustrating the MRAM device 102 of FIG. 3. As shown by FIG. 4, the MRAM device 102 comprises a series of memory cells (described below) and a sensor 103 for informing the controller 172 (FIG. 3) of MRAM device 102 availability within the replacement memory device 100 (FIG. 3). The sensor 103 also senses resistance states of the memory cells 120. An example of circuitry used for sensing resistance states of the memory cells 120 is disclosed by U.S. Pat. No. 6,259,644, entitled “Equipotential Sense Methods For Resistive Cross Point Memory cell arrays,” by Tran, et al., which is hereby incorporated by reference in its entirety.

The MRAM device 102 also comprises four word lines 104, 106, 108, 110, and four bit lines 112, 114, 116, 118, wherein the word lines 104, 106, 108, 110 are located above the bit lines 112, 114, 116, 118. The word lines 104, 106, 108, 110 and bit lines 112, 114, 116, 118 are made of a magnetic material, such as, but not limited to, a ferromagnetic material. It should be noted that the number of word and/or bit lines located within the MRAM device 102 may be more or fewer than the number illustrated by FIG. 4. As shown by FIG. 4, the sensor 103 is connected to the word lines 104, 106, 108, 110 of the MRAM device 102. It should be noted, however, that the sensor 103 may instead be connected to the bit lines 112, 114, 116, 118 of the MRAM device 102.

A memory cell 120 is located at each intersection of a word line and a bit line, wherein word lines extend along a Y-axis and bit lines extend along an X-axis. It should be noted that in accordance with an alternative embodiment of the invention, the word lines 104, 106, 108, 110 may be non-perpendicular to the bit lines 112, 114, 116, 118. Each memory cell 120 stores a bit of data as an orientation of magnetization. The magnetization of each memory cell 120 within the MRAM device 102 assumes one of two stable orientations at a given time. The two stable orientations, namely, parallel and anti-parallel, represent logic values of zero (0) and one (1).

Since a memory cell 120 is located at each intersection of a word line 104, 106, 108, 110 and a bit line 112, 114, 116, 118, the number of memory cells 120 located within the MRAM device 102 is directly associated with the number of word lines 104, 106, 108, 110 and bit lines 112, 114, 116, 118 located within the MRAM device 102. As an example, a 64×64 MRAM device comprises 64 word lines, 64 bit lines, and 4,096 memory cells. As a further example, a 1024×1024 MRAM device comprises 1024 word lines, 1024 bit lines, and 1,048,576 memory cells.

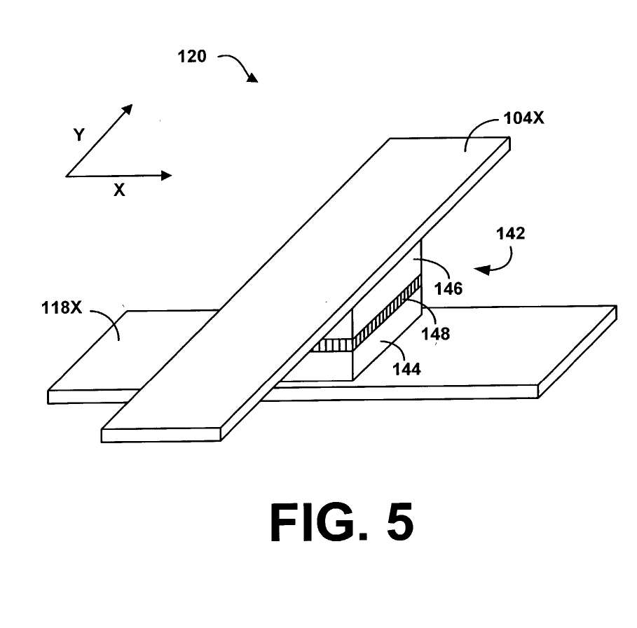

FIG. 5 is a block diagram further illustrating a single memory cell 120 of the MRAM device 102 of FIG. 4. The memory cell 120 comprises a portion 118X of a bit line 118 and a portion 104X of a word line 104. A magnetic tunnel junction 142 is located between the bit line portion 118X and the word line portion 104X. The magnetic tunnel junction 142 comprises two magnetic layers 144, 146 and an insulating layer 148. The first magnetic layer 144 is also referred to as a fixed magnetic layer 144. The fixed magnetic layer 144 has a magnetization that is oriented in the plane of the fixed magnetic layer 144, but that is fixed so as not to rotate in the presence of an applied magnetic field in a range of interest. It should be noted that the fixed magnetic layer 144 may comprise more than one layer or films.

The second magnetic layer 146 is also referred to as a free magnetic layer 146. The free magnetic layer 146 has a magnetization that is not fixed. Rather, the magnetization of the free magnetic layer 146 can be oriented in either of two directions along an axis lying in the plane of the fixed magnetic layer 144. If the orientations of magnetization of the free magnetic layer 146 and of the fixed magnetic layer 144 are in the same direction, then the orientations are said to be parallel. If the orientations of magnetization of the free magnetic layer 146 and of the fixed magnetic layer 144 are in opposite directions, then the orientations are said to be anti-parallel. It should be noted that, similar to the fixed magnetic layer 144, the free magnetic layer 146 may comprise more than one layer or films.

The magnetization in the free magnetic layer 146 may be oriented by applying a current to the word line 104 and the bit line 118 that cross the memory cell 120. The magnetic layers 144, 146 comprise a material that is capable of being well magnetized such as, for example, but not limited to, iron, nickel, and cobalt, or a combination thereof.

The free magnetic layer 146 and the fixed magnetic layer 144 are separated by the insulating layer 148, which is an insulating tunnel barrier that comprises a suitable insulating material such as, but not limited to, aluminum oxide. The insulating layer 148 is thin enough to allow tunneling of electrons between the free magnetic layer 146 and the fixed magnetic layer 144. As an example, the insulting layer 148 may be between five (5) and twenty (20) angstroms thick. Of course, other sizes of the insulating layer 148 may be utilized as well. It should also be noted that the insulting layer 148 may comprise numerous layers or films.

Although the free magnetic layer 146 and the fixed magnetic layer 144 are shown as being respectively above and below the insulating layer 148, the relative positions of the free magnetic layer 146 and the fixed magnetic layer 144 may be interchanged, as will be understood by those of ordinary skill in the art. The insulating layer 148 allows quantum mechanical tunneling to occur between the free magnetic layer 146 and the fixed magnetic layer 144. Tunneling is electron spin dependent, making resistance of the memory cell 120 a function of relative orientations of magnetization of the free magnetic layer 146 and of the fixed magnetic layer 144.

Unfortunately, access time of the sensor 103 (FIG. 4) located within the MRAM device 102 is much slower than access time of the NOR Flash RAM 24 (FIG. 1) being replaced. As an example, the access time of the sensor 103 (FIG. 4) may be approximately twenty microseconds (20 μs), while the access time of the NOR Flash RAM 24 (FIG. 1) may be approximately fifty to one hundred and fifty nanoseconds (50-150 ns). Therefore, while direct replacement of the NOR Flash RAM 24 (FIG. 1) with the MRAM device 102 (FIG. 3) would enable the computer 50 of FIG. 2 to maintain its state even when power is removed, direct replacement would severely slow execution of functions that formerly utilized the NOR Flash RAM 24 (FIG. 2).

Returning to FIG. 3, due to the above-mentioned disadvantage introduced by direct replacement of the NOR Flash RAM 24 (FIG. 2) with the MRAM device 102, the temporary memory 182 is located within the replacement memory device 100. The temporary memory 182 is a high-speed volatile memory that provides the replacement memory device 100 with data access speed that is comparable to data access speed of the NOR Flash RAM 24 (FIG. 1). A detailed discussion of the temporary memory 182 and its use within the replacement memory device 100 is provided by the description of FIG. 6 provided below.

In accordance with the first exemplary embodiment of the invention, the temporary memory 182 is a DRAM due to the high density characteristics of DRAM and minimal cost in comparison to other high-speed volatile memories. Alternatively, if low density is a desired trait of the replacement memory device 100, the temporary memory 182 may be static random access memory (SRAM) or any other fast access storage element, such as, but not limited to, flip-flops or latches. Since limited density increases cost, the first exemplary embodiment of the invention does not use an SRAM, but instead, uses a DRAM.

FIG. 6 is a flowchart illustrating use of the present replacement memory device 100 (FIG. 3). Any process descriptions or blocks in the present flowchart should be understood as representing modules, segments, or portions of code which include one or more executable instructions for implementing specific logical functions or steps in the process, and alternative implementations are included within the scope of the first exemplary embodiment of the invention in which functions may be executed out of order from that shown or discussed, including substantially concurrently or in reverse order, depending on the functionality involved, as would be understood-by those of ordinary skill in the art of the present invention.

As shown by block 202, at startup of the computer 50 (FIG. 2) the processor 52 (FIG. 2) detects whether there is an MRAM device 102 (FIG. 3) located within the computer 50 (FIG. 2). Detection of the MRAM device 102 (FIG. 3) may be performed by the processor 52 (FIG. 2) by transmitting a request to communicate with the MRAM device 102 (FIG. 3) to the controller 172 (FIG. 3). After the controller 172 (FIG. 3) receives the request to communicate, the controller 172 (FIG. 3) transmits a status check to the sensor 103 (FIG. 4) to determine status of the MRAM device 102 (FIG. 3).

Assuming that the MRAM device 102 (FIG. 3) has been initialized and is ready for use by the computer 50 (FIG. 2), data stored within the MRAM device 102 (FIG. 3) is copied by the controller 172 (FIG. 3) to the temporary memory 182 (FIG. 3) (block 204). As shown by block 206, the controller 172 (FIG. 3) monitors for access requests to the temporary memory 182 (FIG. 3) and/or the MRAM device 102 (FIG. 3).

If the controller 172 (FIG. 3) receives a read request from the processor 52 (FIG. 2) as a result of a data request from a source, the controller 172 (FIG. 3) searches the temporary memory 182 (FIG. 3) for the requested data (block 208). If the data is located in the temporary memory 182 (FIG. 3), the data is retrieved by the controller 172 (FIG. 3) and transmitted to the processor 52 (FIG. 2) (block 212). The processor 52 (FIG. 2) may then transmit the data to a source of the data request. Alternatively, the MRAM device 102 (FIG. 3) may be searched after the temporary memory 182 (FIG. 3) is searched, however, retrieval of data from the MRAM device 102 (FIG. 3) does not provide the benefit of fast data access speed associated with use of the temporary memory 182 (FIG. 3). After transmission of the data, the controller 172 (FIG. 3) continues monitoring for access requests to the temporary memory 182 (FIG. 3) and/or the MRAM device 102 (FIG. 3) (block 206).

If the controller 172 (FIG. 3) receives a write request for data that is destined for the MRAM device 102 (FIG. 3), the controller 172 (FIG. 3) writes the data to the temporary memory 182 (FIG. 3) (block 214) for temporary storage. Since data is written to the temporary memory 182 (FIG. 3) and temporarily stored, fast data access is readily available. Specifically, fast data access is readily available because the temporary memory 182 (FIG. 3) is a high-speed volatile memory. After the data is written to the temporary memory 182 (FIG. 3) (block 214) and temporarily stored, the data is placed into an MRAM write queue (block 216) within the temporary memory 182 (FIG. 3), after which the data may be transmitted to the MRAM device 102 (FIG. 3) for storage (block 218).

When the MRAM device 102 (FIG. 3) is in operation, data is moved rapidly from the MRAM write queue to the MRAM device 102 (FIG. 3). Since the write time for the temporary memory 182 is much faster that the read time for the MRAM device 102 (FIG. 3), data may be continuously read from the MRAM device 102 (FIG. 3). However, in the event that the MRAM write queue is full, the controller 172 (FIG. 3) no longer writes data to the temporary memory 182 (FIG. 3). Once a portion of the write queue is emptied, the controller 172 (FIG. 3) may continue writing to the MRAM write queue.

In accordance with the first exemplary embodiment of the invention, a copy of data located within the MRAM write queue is temporarily stored within the temporary memory 182 (FIG. 3), thereby enabling fast data access. The controller 172 (FIG. 3) then continues monitoring for access requests to the temporary memory 182 (FIG. 3) and/or the MRAM device 102 (FIG. 3) (block 206).

If the computer 50 (FIG. 2) begins a power down sequence, data remaining within the MRAM write queue is transmitted to the MRAM device 102 (FIG. 3) to prevent loss of the data (block 222). Transmitting data from the temporary memory 182 (FIG. 3) to the MRAM device 102 (FIG. 3) removes the disadvantage of losing data temporarily stored within the temporary memory 182 (FIG. 3) when there is a loss of power to the computer 50 (FIG. 2). Therefore, the replacement memory device 100 (FIG. 3) provides data access speed benefits of the temporary memory 182 (FIG. 3) and long term data storage benefits of the MRAM device 102 (FIG. 3).

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

The following is claimed:

1. A magnetic memory device capable of replacing a Flash memory within a computer, said magnetic memory device comprising:
a magnetic storage device;
a temporary memory having data access speed similar to said Flash memory; and
a controller for controlling access to said magnetic storage device and said temporary memory.

2. The magnetic memory device of claim 1, wherein said temporary memory is volatile memory.

3. The magnetic memory device of claim 2, wherein said volatile memory is dynamic random access memory.

4. The magnetic memory device of claim 1, wherein said magnetic storage device is a magnetic random access memory.

5. The magnetic memory device of claim 1, wherein said controller is a central processing unit.

6. The magnetic memory device of claim 1, wherein said controller is configured to copy data within said magnetic storage device to said temporary memory during initiation of said computer, and wherein a search for data within said magnetic storage device begins with a search for said data within said temporary memory.

7. The magnetic memory device of claim 1, wherein said controller is configured to write data that is to be written to said magnetic storage device to a write queue within said temporary memory, for transmission to said magnetic storage device.

8. A method for providing a computer with magnetic storage capability, comprising the steps of:
replacing a Flash memory located within said computer with a magnetic memory device comprising a magnetic storage device, a temporary memory and a controller;
copying data stored within said magnetic storage device to said temporary memory during initiation of said computer;
storing data received by said magnetic memory device within said temporary memory; and
transmitting a copy of said data received by said magnetic memory device from said temporary memory to said magnetic storage device.

9. The method of claim 8, further comprising the step of said controller searching said temporary memory for data in response to a data request.

10. The method of claim 9, further comprising the step of said controller searching said magnetic storage device for said requested data if said requested data is not located within said temporary memory.

11. The method of claim 8, wherein said received data stored within said temporary memory is placed within a write queue located within said temporary memory for transmission to said magnetic storage device.

12. The method of claim 8, wherein the step of replacing comprises replacing a magnetic random access memory.

13. The method of claim 8, wherein said temporary memory is a non-volatile memory.

14. The method of claim 13, wherein said non-volatile memory is a dynamic random access memory.

15. A system for replacing a Flash memory within a computer, comprising:
means for magnetically storing data;
means for temporarily storing data; and
means for processing, wherein said means for processing is capable of performing the steps of:
copying data stored within said means for magnetically storing data and transferring said copied data to said means for temporarily storing data, during initiation of said computer; and
searching said means for temporarily storing data in response to a data request.

16. The system of claim 15, wherein said means for processing is capable of performing the step of transmitting data received by said system to a write queue located within said means for temporarily storing data.

17. The system of claim 16, wherein said means for processing is capable of copying said data transmitted to said write queue and transmitting said copied data to said means for magnetically storing data.

18. The system of claim 15, wherein said means for temporarily storing data is a non-volatile memory.

19. The system of claim 18, wherein said means for temporarily storing data is a dynamic random access memory.

20. The system of claim 15, wherein said means for magnetically storing data is a magnetic random access memory.
